(19) United States
(12) Patent Application Publication
(10) Pub. No.: US 2018/0009717 A1
(43) Pub. Date: Jan. 11, 2018

(54) CERAMIC PRODUCTS AND METHODS OF MAKING THEREOF

(71) Applicant: Alcoa USA Corp., Pittsburgh, PA (US)

(72) Inventors: Benjamin D. Mosser, Pittsburgh, PA (US); James C. McMillen, Pittsburgh, PA (US); William Wolf, West Mifflin, PA (US); Lance M. Sworts, New Kensington, PA (US); Artemas Steere, Lower Burrell, PA (US)

(21) Appl. No.: 15/643,149

(22) Filed: Jul. 6, 2017

Related U.S. Application Data
(60) Provisional application No. 62/358,781, filed on Jul. 6, 2016.

(51) Int. Cl. C04B 35/58; C04B 35/645; C04B 35/64; C04B 35/626; C04B 35/63

(52) U.S. Cl. CPC C04B 35/58071; C04B 35/62655; C04B 35/6303; C04B 35/64; C04B 35/6455; C04B 35/6262; C04B 2235/404; C04B 2235/405; C04B 2235/604; C04B 2235/6567; C04B 2235/96; C04B 2235/3813

(57) ABSTRACT

In some embodiments, a ceramic armor product includes: a ceramic powder; an at least one metal-based additive; and a density of 4.3-4.7 g/cc, wherein the ceramic armor product is substantially lacking grain orientation. In some embodiments, a ceramic armor product, includes: a ceramic powder, wherein the ceramic powder is titanium diboride (TiB2); an at least one metal-based additive, wherein the at least one metal based additive comprises elements ranging from atomic numbers 21 through 30, 39 through 51, and 57 through 77; and a density of 4.3-4.7 g/cc, wherein the ceramic armor product is substantially lacking grain orientation.

### CROSS-REFERENCE TO RELATED APPLICATIONS

This application claims benefit of U.S. provisional application Ser. No. 62/358,781, filed Jul. 6, 2016, which is herein incorporated by reference in its entirety.

### FIELD OF THE INVENTION

Broadly, the invention relates to ceramic products and method of making ceramic products.

### BACKGROUND

Through carbothermic synthesis, it is possible to make various boride, nitride, and/or carbide ceramic powders. The ceramic powder can then be processed into final ceramic products for a wide variety of applications.

### SUMMARY OF THE INVENTION

In some embodiments, a ceramic armor product includes: a ceramic powder; an at least one metal-based additive; and a density of 4.3-4.7 g/cc, wherein the ceramic armor product is substantially lacking grain orientation.

In some embodiments, the at least one metal based additive is selected from the group consisting of Fe, Ni, Co, W, Cr, Mn, MO, Pt, and Pd and combinations thereof.

In some embodiments, the at least one metal based additive comprises elements ranging from atomic numbers 21 through 30, 39 through 51, and 57 through 77.

In some embodiments, the ceramic armor product comprises 0.1-1 wt % of the at least one metal based additive.

In some embodiments, the ceramic powder is titanium diboride (TiB2).

In some embodiments, the titanium diboride (TiB₂) powder has a surface area of 1.5-4 m²/g.

In some embodiments, a ceramic armor product, includes: a ceramic powder, wherein the ceramic powder is titanium diboride (TiB2); an at least one metal-based additive, wherein the at least one metal based additive comprises elements ranging from atomic numbers 21 through 30, 39 through 51, and 57 through 77; and a density of 4.3-4.7 g/cc, wherein the ceramic armor product is substantially lacking grain orientation.

In some embodiments, the at least one metal based additive is selected from the group consisting of Fe, Ni, Co, W, Cr, Mn, MO, Pt, and Pd and combinations thereof.

In some embodiments, the ceramic armor product comprises 0.1-1 wt % of the at least one metal based additive.

In some embodiments, the titanium diboride (TiB₂) powder has a surface area of 1.5-4 m²/g.

In some embodiments, a method of forming a ceramic armor product, includes: (a) mixing incoming materials (“precursors”); (b) drying the mixed precursors; (c) exposing the mixed precursors to a reactor to synthesize TiB2; (d) milling the TiB2; (e) adding metal-based additives to the TiB2 to form a first mixture; (f) drying the first mixture by a spray dry process; (g) pressing the first mixture by use of at least one of a uniaxial dry press or a cold isostatic press; (h) one of sintering or hot isostatic pressing (HIP) the first mixture; (i) following sintering or HIP, processing the first mixture using at least one of an electrical discharge machine or grinder; and (j) forming the ceramic armor product.

In some embodiments, sintering is performed at a temperature of 1650-2000° C.

In some embodiments, sintering is performed for 2-12 hours.

In some embodiments, HIP is performed at a temperature of 1400-2000° C.

In some embodiments, HIP is performed for 1-6 hours.

In some embodiments, HIP is performed in an argon gas atmosphere at 1500 psi for 4 hours

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 illustrates flow-chart of an embodiment of the inventive process of the present invention.

FIG. 2 shows the results of ballistic testing of embodiments of the inventive product compared with a known standard.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The present invention will be further explained with reference to the attached drawings, wherein like structures are referred to by like numerals throughout the several views.

The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.

As used herein, “agglomeration” refers to particles clumped or bonded together into clusters.

As used herein, “de-agglomerating” refers to separating particles that are clumped or bonded together in an agglomeration. In some embodiments, de-agglomerating is completed by milling. Non-limiting examples of deagglomerating include, for example, commutation methods known in the art, such as, milling, ultrasonics, jet milling, and combinations thereof In some embodiments, the method includes deagglomerating titanium diboride (TiB2) to remove a plurality of agglomerations in the TiB2.

As used herein, “milling” refers to a process that reduces the size of a material. For example, milling may be used in the TiB2 in order to remove agglomerations, while maintaining the TiB2 particle sizes (e.g., break up clumps of particles while particles remain intact).

As used herein, “morphology” refers to: the form of a material. In some embodiments, the morphology is quantified via average particle size distribution (e.g. as determined through laser diffraction, ASTM C 1070-01, average surface area (determined through BET method-ASTM C1274-12), and visual inspection (i.e. to assign a geometry to the powder) completed via SEM.

As used herein, “surface area” refers to the amount of exposed area a solid object has, expressed in square units. Surface area is measured in units of m²/g. Generally, the larger the surface area of a sample of particles, the smaller the individual particles of the sample being measured.

As used herein, “particle size” refers to the effective length of a particle (for example, the length of a TiB2 particle). As used herein, “total porosity” is related to the percent of the theoretical density. For example, if a material has a density of about 90% of its theoretical density, it has about 10% total porosity (100%−90%=10%). That is, the 100% theoretical density of an object minus the actual density of the object equals its total porosity (TD−AD=TP). The total porosity is the combined amounts of the open (apparent) porosity and the closed porosity (TP=OP+CP). An apparent porosity of a material can be determined via Archimedes principle as embodied in ASTM C373-88(2006) Standard Test Method for Water Absorption, Bulk Density, Apparent Porosity, and Apparent Specific Gravity of Fired Whiteware Products.

As used herein, a “theoretical density” or “ρ_{theory}” is the highest density that a material could achieve as calculated from the atomic weight and crystal structure.

ρ_{theory}=N_{C}A/V_{C}N_{A}

### Where:

N_{C}=number of atoms in unit cell
A=Atomic Weight [kg mol⁻¹]
V_{C}=Volume of unit cell [m³]
N_{A}=Avogadro's number [atoms mol⁻¹]
For the purposes of this patent application the theoretical density is 4.52 g/cc, which is the approximate theoretical density of pure TiB2.

As used herein, an “inert gas” refers to a non-reactive gas. As a non-limiting example, the inert gas may be a noble gas or other gas which prevents atmospheric reactions with chemical reagents. In one embodiment, inert gas covers the precursor mixture and prevents, reduces, and/or eliminates non-desirable side reactions. For example, the inert gas may remove non-desirable intermediate species or mineralizing components from the reactor to drive the production of a high purity TiB2 product. Some examples of the inert gas include but are not limited to, for example: argon, helium, krypton, and neon.

As used herein, “producing” means any conventional method of making.

In some embodiments of the present invention, the inventive product can be used to make the following non-limiting items: sputtering targets, evaporator boats, wear parts, can tooling, high performance brake pads, and bearings.

In some embodiments, the present invention is an armor product comprising a ceramic powder and at least one metal-based additive, where the at least one metal-based additive is Fe, Ni, Co, W, Cr, Mn, Mo, Pt, Pd, or any combination thereof.

In some embodiments, the present invention is an armor product, where the armor product comprises TiB2 and at least one metal-based additive, where the at least one metal-based additive is Fe, Ni, Co, W, Cr, Mn, Mo, Pt, Pd, or any combination thereof, characterized by (1) having a density of 4.3-4.7 grams/centimeter³ (g/cc) and (2) substantially lacking grain orientation (i.e. the grains are oriented in random directions).

In some embodiments, the present invention is an armor product, where the armor product comprises TiB2 and at least one metal-based additive, where the at least one metal-based additive is 0.4 wt % Ni, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % W, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Fe, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Ni, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Co, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Cr, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Mn, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Mo, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Pt, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 1 wt % Pd, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Ni, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-2 wt % Ni, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % W, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Fe, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Co, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Cr, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Mn, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Mo, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Pt, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1 wt % Pd, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-1.5 wt % Ni, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Ni, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % W, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Fe, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Co, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Cr, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Mn, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Mo, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Pt, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where the at least one metal-based additive is 0.1-0.5 wt % Pd, characterized by (1) having a density of 4.3-4.7 grams/centimeter³ (g/cc) and (2) substantially lacking grain orientation.

In some embodiments, the present invention is an armor product, where the armor product comprises TiB2 and at least one metal-based additive, where a first metal-based additive is 0.4 wt % Ni, where a second metal-based additive is 1% W, characterized by (1) having a density of 4.3 -4.7 grams/centimeter³ (g/cc) and (2) substantially lacking grain orientation.

In some embodiments, the present invention is an armor product comprising at least one metal-based additive, where the at least one metal-based additive is Fe, Ni, Co, W, Cr, Mn, Mo, Pt, Pd, or any combination thereof, and a TiB2 powder, where the TiB2 powder is less than 2 microns and has a surface area of 1.5-4 meters²/grams (m²/g), with a density of 4.3-4.7 g/cc. In some embodiments, the inventive product is produced using a sintering and/or a hot isostatic pressing method (HIP).

In some embodiments, the present invention is an armor product comprising a TiB2 powder with a density of 4.3-4.7 g/cc and a surface area of 1.5-4 m²/g, where the armor product comprises grains having substantially no orientation. In some embodiments, the armor product is a tile.

V₅₀ Ballistic Test for Armor

In some embodiments, the V₅₀ ballistic test for armor is configured to meet the standards as set forth and detailed in the “Department of Defense Test Method Standard: V₅₀ ballistic test for armor,” MIL-STD-662F, Dec. 18, 1997.

In an embodiment, average projectile speed, V_{P} can be obtained from:

Vₚ=Vo αR

exp (αR)−1

where

V₀=muzzle velocity

R=range

α=ballistic coefficient

In another embodiment, instrumentation velocities shall be corrected as follows:

Vₛ=V₁−V_{L}

where:

Vₛ=striking velocity at the test sample

V₁=instrumentation velocity

=Distance (between sensory devices)/Time (chronograph reading)

V_{L}=Velocity loss (over target base line)

Velocity loss is calculated in accordance with the following formula:

V_{L}=(XG^{D}rel)/C

where:

X=Distance from baseline to target

G=Drag factor

^{D}rel=Relative air density

C=Ballistic coefficient

As used herein, a “ballistic coefficient” is a parameter or measure which is used to represent or account for the attenuation of the velocity of a projectile or fragment in transit from the firing mechanism to the target. Ballistic coefficients are normally used in approximate formulations to determine average speed or times-of-flight for a projectile.

As used herein, “ballistic impact” is at least one impact due to hits on the target by projectiles, fragments, or other aerodynamically-affected threat mechanisms.

As used herein, “ballistic limit” as measured by MIL-STD-662F (Dec. 18, 1997) is the minimum velocity at which a particular projectile is expected to consistently, completely penetrate armor of given thickness and physical properties at a specified angle of obliquity. In some embodiments of the present invention, certain approaches lead to approximation of the “V₅₀ Point” or “V₅₀ ballistic limit,” that is, the velocity at which complete penetration and incomplete penetration of an armor are equally likely to occur. In some embodiments of the present invention, some methods attempt to approximate the “V₀ Point,” that is, the maximum velocity at which no complete penetration will occur. In some embodiments, some methods attempt to approximate the V₁₀₀ Point, that is, the minimum velocity at which all projectiles will completely penetrate.

As used herein, “ballistic resistance” is a measure of the capability of a material or component to stop or reduce the impact velocity and mass of an impacting projectile or fragment.

As used herein, “initial velocity” is the projectile velocity at the moment that the projectile ceases to be acted upon by propelling forces. In some embodiments, for a gun-fired projectile the initial velocity expressed as ft/s or m/s, is also called “muzzle velocity.”

As used herein, “V₅₀ ballistic limit” is the velocity at which the probability of penetration of an armor material is 50 percent.

In some embodiments of the present invention, the armor product has a density of 4.3-4.65 g/cc. In some embodiments, the armor product has a density of 4.3-4.6 g/cc. In some embodiments, the armor product has a density of 4.3-4.55 g/cc. In some embodiments, the armor product has a density of 4.3-4.5 g/cc. In some embodiments, the armor product has a density of 4.3-4.45 g/cc. In some embodiments, the armor product has a density of 4.3-4.4 g/cc. In some embodiments, the armor product has a density of 4.3-4.35 g/cc. In some embodiments, the armor product has a density of 4.3-4.65 g/cc.

In some embodiments of the present invention, the armor product has a density of 4.35-4.7 g/cc. In some embodiments, the armor product has a density of 4.4-4.7 g/cc. In some embodiments, the armor product has a density of 4.45-4.7 g/cc. In some embodiments, the armor product has a density of 4.5-4.7 g/cc. In some embodiments, the armor product has a density of 4.55-4.7 g/cc. In some embodiments, the armor product has a density of 4.6-4.7 g/cc. In some embodiments, the armor product has a density of 4.65-4.7 g/cc. In some embodiments, the armor product has a density of 4.5-4.54 g/cc.

In some embodiments, visual inspection is utilized to assign a geometry to the TiB2 powder. Some non-limiting examples of geometries include: plate-like, block-like, acicular (needle like), hybrid (two or more types of geometries), and the like. The term “plate-like” refers to powder grains that have a shape with one dimension much smaller than other dimensions of the powder grains.

In an embodiment, the present invention is generated from a ceramic powder, where the powder is titanium diboride (TiB2).

In some embodiments, a mix and match of the metal additives may be incorporated in the precursor mixture to provide a TiB2 powder product having a resulting mixture of processing aids. For example, a composition may include only one, two or many metal additives. In these situations, the additives may be included in the composition in amounts similar to those described above, and the composition may potentially be adjusted to include slightly more of these additives to account for the removal of the other additive(s). In some embodiments, substitutes for Fe, Ni, Co and/or W may be employed, such as Cr, Mn, Mo, Pt, Pd, to name a few. These metal additive substitutes may be employed in addition to, or as a substitute for, the principle metal additives of Fe, Ni, Co, or W.

In some embodiments, the metal-based additives can include elements ranging from atomic numbers 21 through 30, 39 through 51, and 57 through 77. The additives can be added by blending, milling, or by in situ synthesis of the TiB2 powder.

In some embodiments, powder processing used in combination with at least one green forming technique (e.g., injection molding, pressing, extruding, or any combination thereof) results in a higher green density (e.g., >60%).

In some embodiments of the present invention, the TiB2 powder has a surface area of 1.5 m²/g-4 m²/g. In some embodiments, the TiB2 powder has a surface area of 2 m²/g-4 m²/g. In some embodiments, the TiB2 powder has a surface area of 2.5 m²/g-4 m²/g. In some embodiments, the TiB2 powder has a surface area of 3 m²/g-4 m²/g. In some embodiments, the TiB2 powder has a surface area of 3.5 m²/g-4 m²/g.

In some embodiments of the present invention, the TiB2 powder has a surface area of 1.5 m²/g-3.5 m²/g. In some embodiments, the TiB2 powder has a surface area of 1.5 m²/g-3 m²/g. In some embodiments, the TiB2 powder has a surface area of 1.5 m²/g-2.5 m²/g. In some embodiments, the TiB2 powder has a surface area of 1.5 m²/g-2 m²/g.

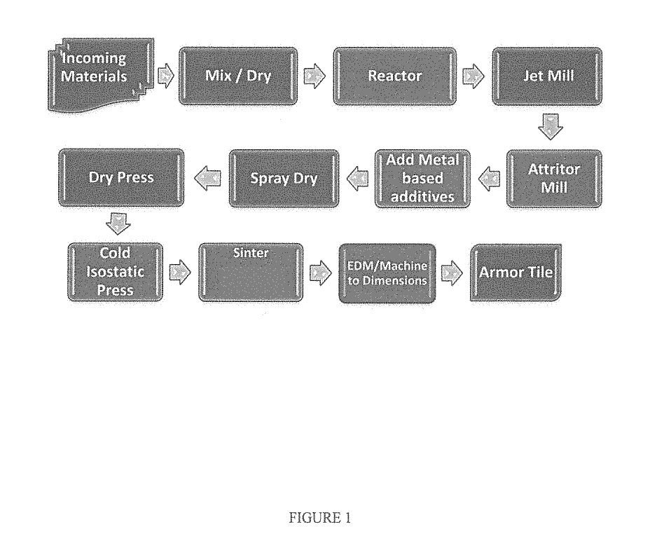

FIG. 1 illustrates a flow-chart of an embodiment of the inventive process of the present invention In some embodiments of the present invention, an armor product is made by: (a) mixing incoming materials (“precursors”), wherein the precursors (e.g. titanium oxide, boric acid and carbon) are suitable for carbothermic synthesis of titanium diboride (TiB2), (b) drying the precursors, (c) exposing the precursors to a reactor to synthesize TiB2, (d) milling the TiB2 (e.g. by use of a jet mill and/or an attritor mill), (e) adding metal-based additives to the TiB2 to form a first mixture, (f) drying the first mixture by a spray dry process, (g) pressing the first mixture (e.g. by use of a uniaxial dry press and/or a cold isostatic press), (h) one of sintering or hot isostatic pressing (HIP) the first mixture, (i) following sintering or HIP, processing the first mixture using an electrical discharge machine and/or grinder, (j) forming a final product, e.g., at least one tile, or any combination thereof. In some embodiments, the first mixture can be sintered followed by hot isostatic pressing of the sintered first mixture.

In some embodiments of the present invention, the inventive method includes sintering at 1650-2000° C. In some embodiments, the inventive method includes sintering at 1675-2000° C. In some embodiments, the inventive method includes sintering at 1700-2000° C. In some embodiments, the inventive method includes sintering at 1725-2000° C. In some embodiments, the inventive method includes sintering at 1750-2000° C. In some embodiments, the inventive method includes sintering at 1775-2000° C. In some embodiments, the inventive method includes sintering at 1800-2000° C. In some embodiments, the inventive method includes sintering at 1825-2000° C. In some embodiments, the inventive method includes sintering at 1850-2000° C. In some embodiments, the inventive method includes sintering at 1875-2000° C.

In some embodiments of the present invention, the inventive method includes sintering at 1650-1975° C. In some embodiments, the inventive method includes sintering at 1650-1950° C. In some embodiments, the inventive method includes sintering at 1650-1925° C. In some embodiments, the inventive method includes sintering at 1650-1900° C. In some embodiments, the inventive method includes sintering at 1650-1875° C. In some embodiments, the inventive method includes sintering at 1650-1850° C. In some embodiments, the inventive method includes sintering at 1750-1825° C. In some embodiments, the inventive method includes sintering at 1650-1800° C. In some embodiments, the inventive method includes sintering at 1650-1775° C.

In some embodiments of the present invention, the inventive method includes sintering for 2-12 hours. In some embodiments, the inventive method includes sintering for 2-11 hours. In some embodiments, the inventive method includes sintering for 2-10 hours. In some embodiments, the inventive method includes sintering for 2-9 hours. In some embodiments, the inventive method includes sintering for 2-8 hours. In some embodiments, the inventive method includes sintering for 2-7 hours. In some embodiments, the inventive method includes sintering for 2-6 hours. In some embodiments, the inventive method includes sintering for 2-5 hours. In some embodiments, the inventive method includes sintering for 2-4 hours. In some embodiments, the inventive method includes sintering for 2-3 hours.

In some embodiments of the present invention, the inventive method includes sintering for 2-11 hours. In some embodiments, the inventive method includes sintering for 3-11 hours. In some embodiments, the inventive method includes sintering for 4-11 hours. In some embodiments, the inventive method includes sintering for 5-11 hours. In some embodiments, the inventive method includes sintering for 6-11 hours. In some embodiments, the inventive method includes sintering for 7-11 hours. In some embodiments, the inventive method includes sintering for 8-11 hours. In some embodiments, the inventive method includes sintering for 9-11 hours. In some embodiments, the inventive method includes sintering for 10-11 hours.

In some embodiments of the present invention, the inventive method includes HIP at 1400-2000° C. In some embodiments, the inventive method includes HIP at 1425-2000° C. In some embodiments, the inventive method includes HIP at 1450-2000° C. In some embodiments, the inventive method includes HIP at 1475-2000° C. In some embodiments, the inventive method includes HIP at 1500-2000° C. In some embodiments, the inventive method includes HIP at 1525-2000° C. In some embodiments, the inventive method includes HIP at 1550-1600° C. In some embodiments, the inventive method includes HIP at 1575-2000° C. In some embodiments, the inventive method includes HIP at 1600-2000° C. In some embodiments, the inventive method includes HIP at 1625-2000° C. In some embodiments, the inventive method includes HIP at 1650-2000° C. In some embodiments, the inventive method includes HIP at 1675-2000° C. In some embodiments, the inventive method includes HIP at 1700-2000° C. In some embodiments, the inventive method includes HIP at 1725-2000° C. In some embodiments, the inventive method includes HIP at 1750-2000° C. In some embodiments, the inventive method includes HIP at 1775-2000° C. In some embodiments, the inventive method includes HIP at 1800-2000° C. In some embodiments, the inventive method includes HIP at 1825-2000° C. In some embodiments, the inventive method includes HIP at 1850-2000° C. In some embodiments, the inventive method includes HIP at 1875-2000° C. In some embodiments, the inventive method includes HIP at 1900-2000° C. In some embodiments, the inventive method includes HIP at 1925-2000° C. In some embodiments, the inventive method includes HIP at 1950-2000° C. In some embodiments, the inventive method includes HIP at 1975-2000° C.

In some embodiments of the present invention, the inventive method includes HIP at 1400-1975° C. In some embodiments of the present invention, the inventive method includes HIP at 1400-1950° C. In some embodiments of the present invention, the inventive method includes HIP at 1400-1925° C. In some embodiments of the present invention, the inventive method includes HIP at 1400-1900° C. In some embodiments of the present invention, the inventive method includes HIP at 1400-1875° C. In some embodiments of the present invention, the inventive method includes HIP at 1400-1850° C. In some embodiments of the present invention, the inventive method includes HIP at 1400-1825° C. In some embodiments of the present invention, the inventive method includes HIP at 1400-1800° C. In some embodiments of the present invention, the inventive method includes HIP at 1400-1775° C. In some embodiments of the present invention, the inventive method includes HIP at 1400-1750° C. In some embodiments of the present invention, the inventive method includes HIP at 1400-1725° C. In some embodiments of the present invention, the inventive method includes HIP at 1400-1700° C. In some embodiments of the present invention, the inventive method includes HIP at 1400-1675° C. In some embodiments of the present invention, the inventive method includes HIP at 1400-1650° C. In some embodiments of the present invention, the inventive method includes HIP at 1400-1625° C. In some embodiments of the present invention, the inventive method includes HIP at 1400-1600° C. In some embodiments of the present invention, the inventive method includes HIP at 1400-1575° C. In some embodiments, the inventive method includes HIP at 1400-1550° C. In some embodiments, the inventive method includes HIP at 1400-1525° C. In some embodiments, the inventive method includes HIP at 1400-1500° C. In some embodiments, the inventive method includes HIP at 1400-1475° C. In some embodiments, the inventive method includes HIP at 1400-1450° C. In some embodiments, the inventive method includes HIP at 1400-1425° C.

In some embodiments of the present invention, the inventive method includes HIP for 1-6 hours. In some embodiments, the inventive method includes HIP for 1-5 hours. In some embodiments, the inventive method includes HIP for 1-4 hours. In some embodiments, the inventive method includes HIP for 1-3 hours. In some embodiments, the inventive method includes HIP for 1-2 hours.

In some embodiments of the present invention, the inventive method includes HIP for 2-6 hours. In some embodiments, the inventive method includes HIP for 3-6 hours. In some embodiments, the inventive method includes HIP for 4-6 hours. In some embodiments, the inventive method includes HIP for 5-6 hours.

In some embodiments of the present invention, the inventive method includes HIP at 1500 psi argon (or other noble gas) gas pressure for 4 hours.

In some embodiments of the present invention, the inventive method uses at least one metal-based additive, where the metal-based additive is a composition comprising 0.01-2.0 wt % nickel and/or up to 1% tungsten. In some embodiments, the metal-based additive is 0.01-1.75% wt % nickel. In some embodiments, the metal-based additive is 0.01-1.5% wt % nickel. In some embodiments, the metal-based additive is 0.01-1.25% wt % nickel. In some embodiments, the metal-based additive is 0.01-1% wt % nickel. In some embodiments, the metal-based additive is 0.01-0.75% wt % nickel. In some embodiments, the metal-based additive is 0.01-0.5% wt % nickel. In some embodiments, the metal-based additive is 0.5-2% wt % nickel. In some embodiments, the metal-based additive is 0.75-2% wt % nickel. In some embodiments, the metal-based additive is 1-2% wt % nickel. In some embodiments, the metal based additive is 1.25-2% wt % nickel. In some embodiments, the metal-based additive is 1.5-2% wt % nickel. In some embodiments, the metal-based additive is 1.75-2% wt % nickel.

In some embodiments, the metal-based additive is 0.01-0.4% wt % nickel. In some embodiments, the metal-based additive is 0.1-0.4% wt % nickel. In some embodiments, the metal-based additive is 0.2-0.4% wt % nickel. In some embodiments, the metal-based additive is 0.3-0.4% wt % nickel. In some embodiments, the metal-based additive is 0.01-0.3% wt % nickel. In some embodiments, the metal-based additive is 0.01-0.2% wt % nickel. In some embodiments, the metal-based additive is 0.01-0.1% wt % nickel.

In some embodiments of the present invention, the metal-based additive is 0.01-1% tungsten. In some embodiments, the metal-based additive is 0.1-1% tungsten. In some embodiments, the metal-based additive is 0.2-1% tungsten. In some embodiments, the metal based additive is 0.3-1% tungsten. In some embodiments, the metal-based additive is 0.4-1% tungsten. In some embodiments, the metal-based additive is 0.5-1% tungsten. In some embodiments, the metal-based additive is 0.6-1% tungsten. In some embodiments, the metal based additive is 0.7-1% tungsten. In some embodiments, the metal-based additive is 0.8-1% tungsten. In some embodiments, the metal-based additive is 0.8-1% tungsten. In some embodiments, the metal-based additive is 0.9-1% tungsten. In some embodiments, the metal based additive is 0.01-0.9% tungsten. In some embodiments, the metal-based additive is 0.01-0.8% tungsten. In some embodiments, the metal-based additive is 0.01-0.7% tungsten. In some embodiments, the metal-based additive is 0.01-0.6% tungsten. In some embodiments, the metal-based additive is 0.01-0.5% tungsten. In some embodiments, the metal-based additive is 0.01-0.4% tungsten. In some embodiments, the metal-based additive is 0.01-0.3% tungsten. In some embodiments, the metal-based additive is 0.01-0.2% tungsten. In some embodiments, the metal-based additive is 0.01-0.1% tungsten.

These and other aspects, advantages, and novel features of the invention are set forth in part in the description that follows and will become apparent to those skilled in the art upon examination of the following description and figures, or may be learned by practicing the invention.

### EXAMPLE

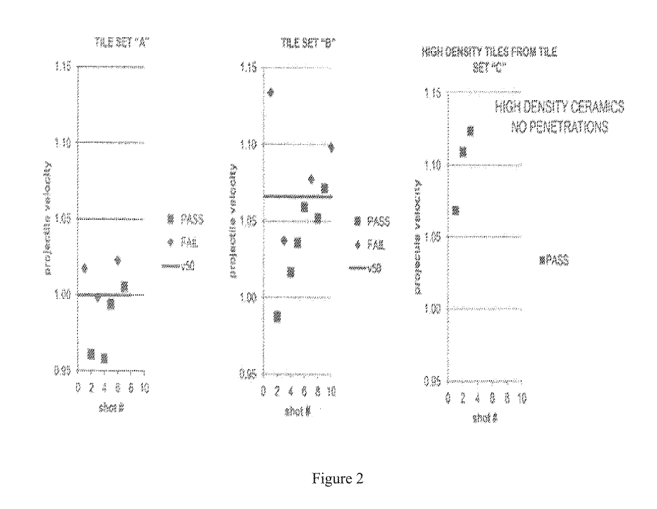

FIG. 2 shows the results of ballistic testing of embodiments of the inventive product compared with a known standard. Ballistic armor tiles were tested, where Tile Set “A” was a standard dense plate, Tile Set “B” was produced by pressureless sintering (e.g., 1800-1900° C. for 2-12 hours, or 1850° C. for 6 hours) and has a density of 95%-96% of a theoretical density, and Tile Set “C” was produced by a process using pressureless sintering (e.g., 1750-1825° C. for 2-4 hours, or 1800° C. for 4 hours and HIP at 1600° C., 1500 psi argon gas pressure for 4 hours. In this example, results regarding ballistic performance of Tile Set “A” and Tile Set “B” indicated comparable ballistic performance of Tile Set “C” having a lower areal density. In this exemplary embodiment, Tile Set “B” demonstrated similar high ballistic performance compared to Tile Set “C”. In this example, the V₅₀s of Tile Set “B” and Tile Set “C” are at least as good as the V₅₀ of Tile Set “A”. V₅₀ is illustrated in FIG. 2 regarding of Tile Set “A” and Tile Set “B” but not regarding Tile Set “C”, as Tile Set “C” did not produce a failed sample. Therefore, the V₅₀ is expected to exceed 1.10.

In this example, the armor product has a density of 4.45-4.5 g/cc (i.e., 98.5-99.6%) (as shown in FIG. 2, Tile Set “A”). The armor product has a density of 4.31- 4.33 g/cc (i.e., 95.4-95.8%) as shown in FIG. 2, Tile Set “B”). The armor product has a density of 4.4-4.51 g/cc (97.3-99.7%) as shown in FIG. 2, Tile Set “C”). The armor product includes TiB2 and a metal-based additive, which is 0.4 wt % Ni and 1% wt % W.

In some embodiments, the armor product has a density that corresponds to >98% (e.g., 98.00000001-100%). In some embodiments, the armor product has a density of 4.5-4.54 g/cc. In some embodiments, the armor product has a density of 4.52 g/cc (as theoretical), then 4.5 g/cc=99.6%. In some embodiments, the armor product has a density of 4.25 g/cc, (equaling 94%).

While various embodiments of the present invention have been described in detail, it is apparent that modifications and adaptations of those embodiments will occur to those skilled in the art. However, it is to be expressly understood that such modifications and adaptations are within the spirit and scope of the present invention.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

We claim:

1. A ceramic armor product, comprising:
a ceramic powder;
an at least one metal-based additive; and
a density of 4.3-4.7 g/cc, wherein the ceramic armor product is substantially lacking grain orientation.

2. The product of claim 1, wherein the at least one metal based additive is selected from the group consisting of Fe, Ni, Co, W, Cr, Mn, MO, Pt, and Pd and combinations thereof.

3. The product of claim 1, wherein the at least one metal based additive comprises elements ranging from atomic numbers 21 through 30, 39 through 51, and 57 through 77.

4. The product of claim 1, wherein the ceramic armor product comprises 0.1-1 wt % of the at least one metal based additive.

5. The product of claim 1, wherein the ceramic powder is titanium diboride (TiB2).

6. The product of claim 5, wherein the titanium diboride (TiB₂) powder has a surface area of 1.5-4 m²/g.

7. A ceramic armor product, comprising:
a ceramic powder, wherein the ceramic powder is titanium diboride (TiB2);
an at least one metal-based additive, wherein the at least one metal based additive comprises elements ranging from atomic numbers 21 through 30, 39 through 51, and 57 through 77; and
a density of 4.3-4.7 g/cc, wherein the ceramic armor product is substantially lacking grain orientation.

8. The product of claim 7, wherein the at least one metal based additive is selected from the group consisting of Fe, Ni, Co, W, Cr, Mn, MO, Pt, and Pd and combinations thereof.

9. The product of claim 7, wherein the ceramic armor product comprises 0.1-1 wt % of the at least one metal based additive.

10. The product of claim 7, wherein the titanium diboride (TiB₂) powder has a surface area of 1.5-4 m²/g.

11. A method of forming a ceramic armor product, comprising:
(a) mixing incoming materials (“precursors”);
(b) drying the mixed precursors;
(c) exposing the mixed precursors to a reactor to synthesize TiB2;
(d) milling the TiB2;
(e) adding metal-based additives to the TiB2 to form a first mixture;
(f) drying the first mixture by a spray dry process;
(g) pressing the first mixture by use of at least one of a uniaxial dry press or a cold isostatic press;
(h) one of sintering or hot isostatic pressing (HIP) the first mixture;
(i) following sintering or HIP, processing the first mixture using at least one of an electrical discharge machine or grinder; and
(j) forming the ceramic armor product.

12. The method of claim 11, wherein sintering is performed at a temperature of 1650-2000° C.

13. The method of claim 12, wherein sintering is performed for 2-12 hours.

14. The method of claim 11, wherein HIP is performed at a temperature of 1400-2000° C.

15. The method of claim 14, wherein HIP is performed for 1-6 hours.

16. The method of claim 11, wherein HIP is performed in an argon gas atmosphere at 1500 psi for 4 hours.
